(19) United States
(12) Patent Application Publication
(10) Pub. No.: US 2026/0361821 A1
(43) Pub. Date: Nov. 12, 2026

(54) IMAGE READING DEVICE, IMAGE READING SYSTEM, METHOD OF CONTROLLING IMAGE READING DEVICE, AND NON-TRANSITORY COMPUTER-READABLE STORAGE MEDIUM STORING A PROGRAM

(71) Applicant: CANON DENSHI KABUSHIKI KAISHA, Saitama-ken (JP)

(72) Inventor: Toshifumi Okano, Tokyo (JP)

(21) Appl. No.: 19/707,977

(22) Filed: Jun. 15, 2026

Related U.S. Application Data
(63) Continuation of application No. PCT/JP2024/044606, filed on Dec. 17, 2024.

(30) Foreign Application Priority Data
Dec. 22, 2023 (JP) 2023-217162

(51) Int. Cl. H04N 1/00

(52) U.S. Cl. CPC H04N 1/00328; H04N 1/00236

(57) ABSTRACT

An image reading device having an image reader that reads an image of an original document. The image reading device outputs a code image readable by a terminal device and performs control to transmit, in response to an image read request, image data obtained by reading an original document using the image reader, to a request source of the read request. The code image contains first connection information for the terminal device to communicably connect to an information processing device, and second connection information for the information processing device or the terminal device to communicably connect to the image reading device.

### CROSS-REFERENCE TO RELATED APPLICATION

This application is a continuation of International Patent Application No. PCT/JP2024/044606 filed on Dec. 17, 2024, which claims priority to and the benefit of Japanese Patent Application No. 2023-217162 filed on Dec. 22, 2023, the entire disclosures of which are incorporated herein by reference.

### BACKGROUND OF THE INVENTION

### Field of the Invention

The present invention relates to an image reading device, an image reading system, a method of controlling an image reading device, and a non-transitory computer-readable storage medium storing a program.

### Description of the Related Art

Image reading devices for electronically storing information written on paper such as an original document have conventionally been used. As image analysis technologies have in recent years been developed, techniques of analyzing an image read by an image reading device and utilizing information obtained as a result of the analysis have been widely used. A large number of such techniques are available as information processing services on the market.

Such information processing services are commonly executed in an external information processing server. Therefore, it is necessary to associate the user's image reading device with the external information processing server.

A problem arises when communication is established between an information processing server and an image reading device in order to associate the image reading device with an information processing service. An information processing server that executes an information processing service needs to communicate with an image reading device in order to provide a user interface, control the image reading device, receive a read image, and the like. To do so, however, it is necessary to register in advance, in the information processing server, connection information such as an IP address required to establish communication with the image reading device, or it is necessary for the user to input such connection information when using the information processing server, leading to a decrease in convenience. Japanese Patent No. 5822040 describes a technique with which even if settings for connecting an image reading device and a terminal device have not previously been performed, the image reading device and the terminal device can be connected, so that document data can be transmitted and received between the image reading device and the terminal device.

In the technique described in Japanese Patent No. 5822040, the terminal device reads a code image displayed on the image reading device and thereby displays a user interface provided by the image reading device. With that technique, the user interface can be provided to the user without an increase in the size and cost of the image reading device. However, the user interface is provided by the image reading device, and not by an information processing server. Therefore, the technique described in Japanese Patent No. 5822040 cannot solve the above problem with the use of an information processing service.

### SUMMARY OF THE INVENTION

Embodiments of the present invention eliminate the above-mentioned issues with conventional technology.

A feature of embodiments of the present invention is to provide a technique for easily associating an image reading device with an information processing service.

According to embodiments of the present invention, there is provided an image reading device comprising: an image reader configured to read an image of a document; and one or more controllers including one or more processors and one or more memories, wherein the one or more controllers are configured to: output a code image readable by a terminal device; and perform control to transmit, in response to an image read request, image data obtained by reading a document using the image reader, to a request source of the read request, wherein the code image contains first connection information for the terminal device to communicably connect to an information processing device, and second connection information for the information processing device or the terminal device to communicably connect to the image reading device.

Further features of the various embodiments will become apparent from the following description of embodiments with reference to the attached drawings. Further, in the accompanying drawings, the same or similar configurations are assigned the same reference numerals, and redundant descriptions are omitted.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a schematic diagram illustrating a configuration of an image reading system according to a first embodiment of the present invention;

FIG. 2 depicts a partially cross-sectional schematic view illustrating a configuration of an image reading device A according to the first embodiment of the present invention;

FIG. 3 is a block diagram for describing a configuration of a control unit of the image reading device A according to the first embodiment of the present invention;

FIG. 4 depicts a front view for describing a display unit of the image reading device A according to the first embodiment of the present invention;

FIG. 5 is a block diagram for describing a configuration of an information processing terminal B according to the first embodiment of the present invention;

FIG. 6 is a flowchart for describing a reading procedure in the image reading system according to the first embodiment;

FIG. 7 is a flowchart for describing a connection process of step S601 of FIG. 6;

FIG. 8 is a flowchart for describing the flow of a process of causing the information processing terminal B to obtain a web application from an information processing server C in step S602 of FIG. 6;

FIG. 9 is a diagram illustrating an example of list information in which the IP address of the image reading device A according to the first embodiment is associated with the IP address of the information processing terminal B according to the first embodiment;

FIG. 10 is a flowchart for describing the flow of a process of causing the information processing server C to generate a web application in step S803 of FIG. 8;

FIG. 11 is a flowchart for describing a process of reading an original document using the information processing terminal B and the image reading device A and transmitting data of the read image to the information processing server C in step S603 of FIG. 6 according to the first embodiment;

FIG. 12 is a flowchart for describing a process of generating a web application that is executed by an information processing server C according to a second embodiment of the present invention (step S1703);

FIG. 13 is a flowchart for describing a process of reading an original document using an image reading device A and an information processing terminal B according to the second embodiment and transmitting data of the read image to the information processing server C according to the second embodiment;

FIG. 14 is a flowchart for describing a process of generating a web application using an information processing server C according to a third embodiment;

FIG. 15 is a flowchart for describing a process of reading an original document using an image reading device A and an information processing terminal B according to the third embodiment and transmitting data of the read image to the information processing server C according to the third embodiment;

FIG. 16 is a sequence diagram for describing an example procedure of processing in the image reading system according to the first embodiment;

FIG. 17 is a sequence diagram for describing an example procedure of processing in an image reading system according to the second embodiment;

FIG. 18 is a sequence diagram for describing an example procedure of processing in an image reading system according to the third embodiment;

FIG. 19A is a diagram illustrating an example UI screen displayed on the information processing terminal B according to the first embodiment;

FIG. 19B is a diagram illustrating an example UI screen displayed on a touch panel of the information processing terminal B according to the first embodiment; and

FIG. 20 is a sequence diagram for describing an example procedure of processing in an image reading system according to a fourth embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

Firstly, a system configuration according to a first embodiment of the present invention will be described.

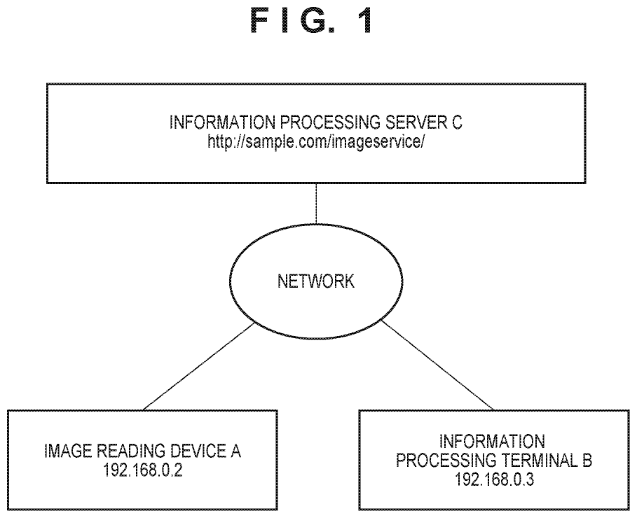

FIG. 1 is a schematic diagram illustrating a configuration of an image reading system according to the first embodiment of the present invention.

An image reading device A (original document reading device), an information processing terminal B, and an information processing server C (information processing device) are connected via a network configured by a local area network (LAN) or a wide area network (WAN). Here, the image reading device A is, for example, a scanner or multifunctional printer (MFP), which is capable of reading an original document. The information processing terminal B is, for example, a mobile information terminal (terminal device) such as a smartphone or personal digital assistant (PDA). It is assumed that an IP address (192.168.0.2) is assigned to the image reading device A, and another IP address (192.168.0.3) is assigned to the information processing terminal B. It is also assumed that the information processing server C can be accessed using a uniform resource locator (URL) (http://sample.com/imageservice/). It should be noted that in the first embodiment, it is assumed that the network allows at least communication between the image reading device A and the information processing terminal B and communication between the information processing terminal B and the information processing server C.

Next, an image reading device according to the first embodiment of the present invention will be described.

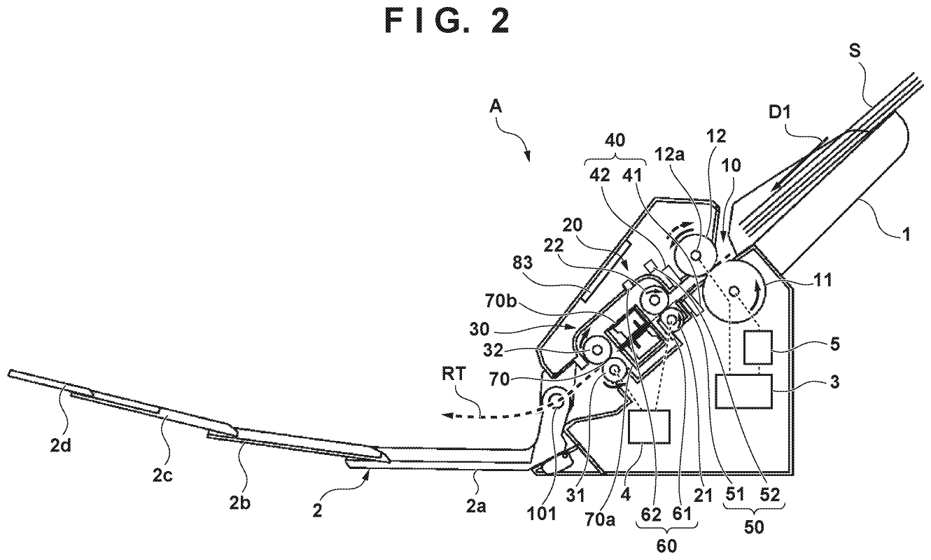

FIG. 2 depicts a partially cross-sectional schematic view illustrating a configuration of the image reading device A according to the first embodiment of the present invention.

### Device Configuration

In the image reading device A, one or more transport media (sheets) S stacked on a feed tray 1 are fed one at a time into the device along a path RT, an image of a transport medium S is read, and the transport medium S is ejected onto an output tray 2 as a stack member. The transport medium S to be read may, for example, be a sheet such as a photograph, office paper, cheque, business card, or card, which may be either thick or thin. Examples of the card include a health insurance card, driver's license card, and credit card, and the like. The transport medium S also includes a booklet such as a passport. In the case in which a booklet is subjected to image reading, a holder may be used. When an opened booklet is contained in a transparent holder and is placed on the feed tray 1, the booklet is transported along with the holder, and an image of the booklet can be read. A reference numeral 83 indicates an operation unit.

### Paper Feed

A first transport unit 10 is provided as a feed mechanism that feeds a transport medium S along the path RT. In this embodiment, the first transport unit 10 includes a feed roller 11, and a separation roller 12 disposed opposite the feed roller 11. The first transport unit 10 transports transport media S on the feed tray 1 in a transport direction D1 in order one at a time. A drive force is transferred to the feed roller 11 from a drive unit 3 such as a motor via a transfer unit 5, so that the feed roller 11 is driven to rotate in a direction indicated by an arrow in FIG. 2 (a forward direction in which a transport medium S is transported along the path RT). The transfer unit 5, which is, for example, an electromagnetic clutch, transfers and interrupts a drive force from the drive unit 3 to the feed roller 11.

### Drive Unit

In the first embodiment, for example, the transfer unit 5, which connects the drive unit 3 and the feed roller 11, transfers a drive force when the transfer unit 5 is in a normal state, and stops the transfer of a drive force when the transfer unit 5 transports a transport medium S backward or stops feeding a transport medium S. The feed roller 11 is put into a state in which the feed roller 11 can be freely rotated when the transfer unit 5 stops the transfer of a drive force. It should be noted that the transfer unit 5 may not be provided in the case in which the feed roller 11 is driven only in one direction.

### Separation Structure

The separation roller 12, which is disposed opposite the feed roller 11, separates a transport medium S from transport media S one at a time, and is in contact with and pressed against the feed roller 11 with a predetermined pressure. In order to ensure the pressed contact state, the separation roller 12 is configured to be able to sway and to be pressed against the feed roller 11. A drive force is transferred to the separation roller 12 from the drive unit 3 via a torque limiter 12a, and is thereby driven to rotate in a direction indicated by a solid line arrow (the direction opposite to the forward direction of the feed roller 11).

The transfer of a drive force is regulated by the torque limiter 12a so that the separation roller 12 rotates in a direction in which the separation roller 12 follows the feed roller 11 (the direction indicated by the dashed line arrow) when the separation roller 12 is in contact with the feed roller 11. As a result, when a plurality of transport media S are transported to a pressed contact portion between the feed roller 11 and the separation roller 12, the plurality of transport media S, except for one transport medium S, are prevented from being transported downstream.

Although in the first embodiment, the separation roller 12 and the feed roller 11 constitute a separation mechanism, such a separation mechanism may not necessarily be provided. Any feed mechanism that feeds transport media S to the path RT in order one at a time may be used. In the case in which a separation mechanism is provided, a separation pad that applies a frictional force to a transport medium S may be brought into contact with and pressed against the feed roller 11 to perform a similar separation action, instead of a configuration such as the separation roller 12.

### Transport Structure

A second transport unit 20 that is positioned downstream of the first transport unit 10 in the transport direction and serves as a transport mechanism, includes a driven roller 21, and an idler roller 22 that follows the driven roller 21. The second transport unit 20 transports a transport medium S transported from the first transport unit 10 downstream. A drive force is transferred to the driven roller 21 from a drive unit 4 such as a motor, so that the driven roller 21 is driven to rotate in a direction indicated by an arrow. The idler roller 22 is in contact with and pressed against the driven roller 21 with a predetermined pressure, and follows the driven roller 21. The idler roller 22 may be configured to be pressed against the driven roller 21 with a press unit (not illustrated) such as a spring.

A third transport unit 30 that is positioned downstream of the second transport unit 20 in the transport direction, includes a driven roller 31, and an idler roller 32 that follows the driven roller 31. The third transport unit 30 transports a transport medium S transported from the second transport unit 20 to the output tray 2. Thus, the third transport unit 30 serves as an ejection mechanism. A drive force is transferred to the driven roller 31 from the drive unit 4, such as a motor, and is thereby driven to rotate in a direction indicated by an arrow. The idler roller 32 is in contact with and pressed against the driven roller 31 with a predetermined pressure, and follows the driven roller 31. The idler roller 32 may be configured to be pressed against the driven roller 31 by a press unit (not illustrated) such as a spring.

The output tray 2, on which original documents are stacked, is borne through a first hinge 101 provided below the image reading device A so that the output tray 2 can rotate with respect to the image reading device A. The output tray 2 has a first output tray 2a closer to the first hinge 101, and a first extension tray 2b, a second extension tray 2c, and a third extension tray 2d, which are connected to a front end of the first output tray 2a. The first extension tray 2b is supported by the first output tray 2a and is allowed to be slid and put into the first output tray 2a. The second extension tray 2c is supported by the first extension tray 2b and is allowed to be slid and put into the first extension tray 2b. The third extension tray 2d is supported by the second extension tray 2c and is allowed to be slid and put into the second extension tray 2c.

### Image Reading Structure and Control

Here, in the image reading device A of the first embodiment, an image is read by an image reading unit (image reader) 70 that is disposed between the second transport unit 20 and the third transport unit 30. To this end, the second transport unit 20 and the third transport unit 30 transport a transport medium S at a constant speed. The transport speed of this constant-speed transport is invariably set to at least the transport speed of the first transport unit 10. This can reliably avoid a situation that a preceding transport medium S is caught up with by a succeeding transport medium S. For example, in the first embodiment, speed control is performed such that the speed at which a transport medium S is transported by the second transport unit 20 and the third transport unit 30 is higher than the speed at which a transport medium S is transported by the first transport unit 10.

It should be noted that even under the condition that the speed at which a transport medium S is transported by the second transport unit 20 and the third transport unit 30 is the same as the speed at which a transport medium S is transported by the first transport unit 10, the minimum acceptable interval between a preceding transport medium S and a succeeding transport medium S can be formed by controlling the drive unit 3 so as to intermittently shift the timing at which feeding of a succeeding transport medium S is started.

### Multi-Feed Detection

A multi-feed detection sensor 40 that is provided between the first transport unit 10 and the second transport unit 20 is an example detection sensor (sensor for detecting the behavior or state of a sheet(s)) that detects when transport media S such as paper sticking together due to static electricity or the like have been passed through the first transport unit 10 (a state in which sheets sticking together are transported (multi-feed)). The multi-feed detection sensor 40 is an ultrasonic sensor in the present embodiment, but various types of sensors can be used as the multi-feed detection sensor 40. The multi-feed detection sensor 40, which includes an ultrasound transmitter 41 and an ultrasound receiver 42, detects multi-feed based on the principle that the amount of attenuation of ultrasound passing through a transport medium(s) S differs between when transport media S such as paper sticking together are transported and when transport media S are transported one at a time.

### Registration Sensor

A medium detection sensor 50 that is disposed downstream of the multi-feed detection sensor 40 in the transport direction is an example detection sensor (sensor for detecting the behavior or state of a sheet) that is disposed upstream of the second transport unit 20 and downstream of the first transport unit 10 and on an upstream side of the path RT. The medium detection sensor 50 detects whether or not a position (specifically, an edge) of a transport medium S transported by the first transport unit 10 has reached or passed through a detection position of the medium detection sensor 50. The medium detection sensor 50 is an optical sensor and includes a light emitter 51 and a light receiver 52 in the present embodiment, but various types of sensors can be used as the medium detection sensor 50. The medium detection sensor 50 detects a transport medium S based on the principle that the intensity (amount) of received light is changed due to a transport medium S reaching or passing through the medium detection sensor 50.

In the first embodiment, the medium detection sensor 50 is provided near and downstream of the multi-feed detection sensor 40 so that at the time when the medium detection sensor 50 detects a leading edge of a transport medium S, the transport medium S has reached a position where multi-feed can be detected by the multi-feed detection sensor 40. It should be noted that the medium detection sensor 50 is not limited to the optical sensor. For example, the medium detection sensor 50 may be a sensor capable of detecting an edge of a transport medium S (an imaging sensor or the like), or a lever-type sensor protruding into the path RT. Alternatively, a plurality of medium detection sensors 50 may be provided in a direction perpendicular to the transport direction so as to be able to detect when a medium is skew with respect to the transport path.

In addition to the medium detection sensor 50, another medium detection sensor 60 is disposed upstream of the image reading unit 70. The medium detection sensor 60 is an example downstream detection sensor that is disposed downstream of the second transport unit 20. The medium detection sensor 60 detects a position of a transport medium S transported by the second transport unit 20. As with the medium detection sensor 50, the medium detection sensor 60 is an optical sensor in the present embodiment, but various types of sensors can be used as the medium detection sensor 60. The medium detection sensor 60 includes a light emitter 61 and a light receiver 62. The medium detection sensor 60 detects a transport medium S based on the principle that the intensity (amount) of received light is changed due to a transport medium S reaching or passing through the medium detection sensor 60. Although in the present embodiment, the medium detection sensors 50 and 60 are disposed upstream and downstream, respectively, of the second transport unit 20 in the transport direction, only one of the medium detection sensors 50 and 60 may be provided.

### Disposition of CIS

For example, the image reading unit 70, which is positioned downstream of the medium detection sensor 60, optically scans and converts an image on a transport medium S into an electrical signal and thereby reads the image as image data. The image reading unit 70 includes a light source such as an LED, an image sensor, a lens array, and the like. The image reading unit 70 is a contact image sensor (CIS) unit. Although the image reading unit 70 is here a CIS unit, the image reading unit 70 may, for example, be a unit employing a CCD as an image sensor. The type of the image sensor is not limited. In an embodiment, the image reading unit 70 (70a, 70b) (this hereinafter has the same meaning as that of a CIS) is disposed on either side of the path RT so that a front and a back surface of a transport medium S are read. However, the image reading unit 70 may be configured to be disposed only on one side of the path RT and to read only one surface of a transport medium S. Although in the embodiment, the image reading units 70 are disposed on both sides of the path RT and opposite each other, the image reading units 70 may, for example, be disposed and spaced from each other along the path RT.

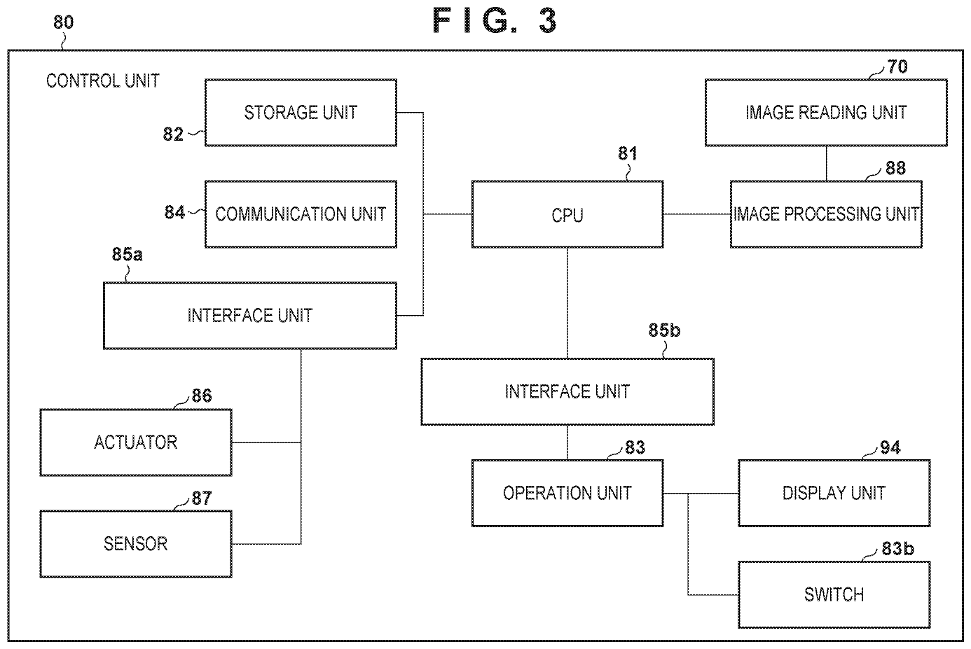

FIG. 3 is a block diagram for describing a configuration of a control unit 80 of the image reading device A according to the first embodiment of the present invention.

The control unit 80 includes a CPU 81, a storage unit 82, a communication unit 84, and an interface unit 85a. The CPU 81 executes programs stored in the storage unit 82 to control various functions including control of reading of the image reading device A, transport and the like of a medium, and reporting to an operator. The operation unit 83, which has, for example, a display unit 94 and a switch 83b, displays information to an operator, and receives an operation from an operator.

Here, the control unit 80 may have a plurality of CPUs, storage units, communication units, and interface units. For example, one CPU may control reading of the image reading device A and transport of a medium, while another CPU may perform reporting to an operator and the like. Thus, the functions may be divided into different groups, which may be controlled by different control systems.

The communication unit 84 includes a communication interface that performs information communication with an external device connected thereto. In the first embodiment, it is assumed that the communication unit 84 includes, as the communication interface, a wireless LAN interface and a wired LAN interface. In the first embodiment, an external device with which the communication unit 84 wirelessly communicates is the information processing terminal B. Although in the first embodiment, as illustrated in FIG. 1, the image reading device A is connected to a LAN, this LAN may be either a wired LAN or a wireless LAN.

In the image reading device A, a web server (not illustrated) is constructed, which can be accessed by an external device connected thereto via a wired LAN. It is also assumed that the web server performs communication via the communication unit 84.

The interface unit 85a, which is an I/O interface connected to the CPU 81, performs input and output of data to and from an actuator 86 and a sensor 87. The actuator 86 includes the drive unit 3, the drive unit 4, and the transfer unit 5, which are described above, and the like. The sensor 87 includes the multi-feed detection sensor 40 and the medium detection sensors 50 and 60, which are described above, and the like. An interface unit 85b is, for example, a control interface connected to the display unit 94 of the operation unit 83. Examples of an interface that performs display control include SPI, USB interface, eDP, and HDMI.

### Configuration of Display Panel

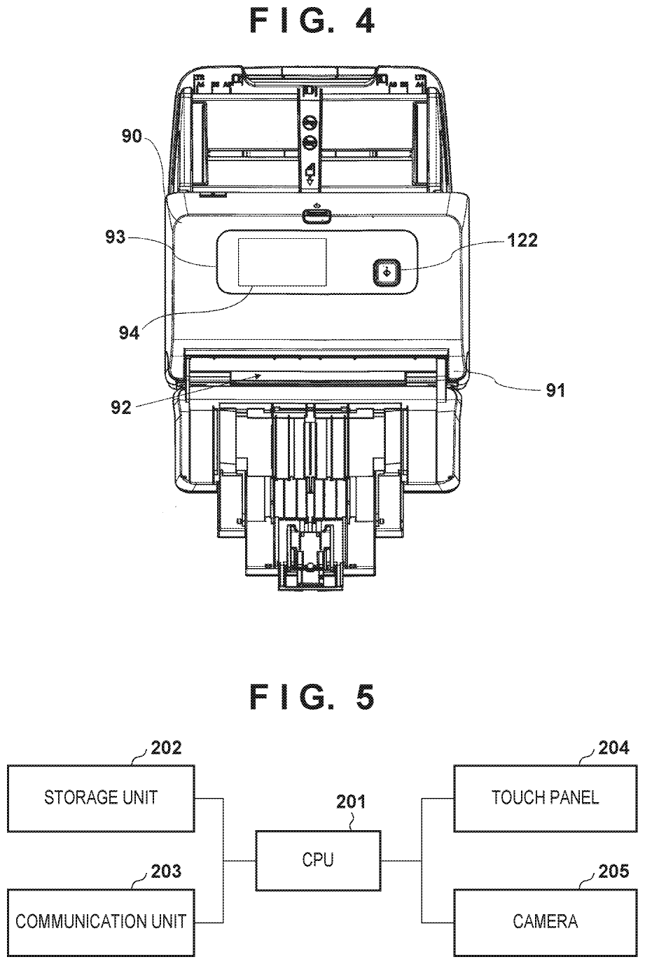

FIG. 4 depicts a front view for describing a display unit of the image reading device A according to the first embodiment of the present invention. More specifically, FIG. 4 is a diagram of the image reading device A as viewed in a direction perpendicular to a front panel 90, which is sloped forward, and is also a diagram of the image reading device A as viewed from slightly above the front of the image reading device A when the image reading device A is placed.

A display panel 93 is provided in the front panel 90, which is provided at an upper portion of the front. The display panel 93 includes a power button 122 that is an example switch as an example of the operation unit 83, and the display unit 94. The display unit 94, which is, for example, a liquid crystal display, is capable of displaying a screen corresponding to a state of the image reading device A and thereby providing device information to an operator. Examples of the displayed screen include a list or the like of jobs specifying a reading operation (e.g., a reading resolution, a method for outputting data of a read image, and an output destination) previously stored in the image reading device A, and a two-dimensional code image that can be read by the information processing terminal B. An icon indicating a state of the image reading device A or the like may be additionally displayed.

### Control During Multi-Feed

By performing an image reading operation, the multi-feed detection sensor 40 determines whether there is multi-feed, in the middle of transport of a transport medium S. If it is not determined that there is multi-feed, transport is continued. It should be noted that if it is determined that there is multi-feed, transport may be stopped or the first transport unit 10 may stop taking a succeeding transport medium S, and transport media S in the multi-feed state may be directly ejected. A report that multi-feed has occurred may be displayed on an external personal computer or the display unit 94 of the image reading device A. At this time, a restoration process may also be selected by an operator, including, for example, continuing reading, or discarding read data of transport media S that is double fed and restarting reading of transport media S from which image reading data has not been obtained, including the transport media S that are double fed. Start of reading in response to output of registration sensor and transmission and storage of read image

The control unit 80 starts reading of an image of a transport medium S transported by the second transport unit 20 using the image reading unit 70 at a timing based on the result of detection by the medium detection sensor 60, executes image processing on data of the read image, temporarily stores the resultant image data, and sequentially transmits the image data out of the device. The temporarily stored image data is transmitted to a connected external personal computer or network device via the communication unit 84. Here, the external personal computer may store the received read image after displaying the received read image. Alternatively, the external personal computer may directly store the received read image into a predetermined place. The read image may also be stored on a device on a network, including, for example, a predetermined place such as an external storage device directly connected to a network or an FTP server. It should be noted that image processing on data of an image read by the image reading unit 70 may be executed by either the control unit 80 or an external personal computer or external device. A plurality of functions may, of course, be divided into different groups, which may be executed by different control units 80, external personal computers, or external devices.

### Paper Ejection Structure

A transport medium S from which an image has been read is ejected onto the output tray 2 by the third transport unit 30, and the image reading process on the transport medium S ends. The output tray 2 is an example of an original document stack tray.

An ejection opening 92 is provided in a lower panel 91 at a lower portion of the front. A transport medium S is transported and ejected through the ejection opening 92 by the third transport unit 30.

### Drive in Response to Reception of Start Instruction From Outside

Next, a basic operation of the image reading device A will be described. When the control unit 80 receives an instruction to start image reading from, for example, an external personal computer or control device connected to the image reading device A, the control unit 80 starts driving the first transport unit 10, the second transport unit 20, and the third transport unit 30. Transport media S stacked on the feed tray 1 are transported, one at a time, starting from the lowest transport medium S in the stack. It should be noted that in the first embodiment, the instruction to start image reading is received from the information processing terminal B.

### Start of Reading in Response to Output of Registration Sensor

The control unit 80 reads a transport medium S transported by the second transport unit 20 using the image reading unit 70. Here, the reading is started at a timing based on the result of detection by the medium detection sensor 60 included in the sensor 87. The control unit 80 accepts image data of read image from the image reading unit 70 at regular intervals depending on a set reading resolution and a set movement speed of a transport medium S.

### Image Processing on Read Image

An image read by the image reading unit 70 is subjected to various processes in an image processing unit 88 before being transmitted to an external control device via the communication unit 84.

Here, as described above, the image reading units 70a and 70b are disposed with the second transport unit 20 interposed therebetween, and read both surfaces of a transport medium S. An operator is instructed to, when placing a transport medium S on the feed tray 1, place the transport medium S with the front surface of the transport medium S in contact with the tray, that is, the operator can see the back surface of the transport medium S when the transport medium S is placed on the feed tray 1. The transport medium S is transported, the front surface of the transport medium S is read by the image reading unit 70a, and the back surface of the transport medium S is read by the image reading unit 70b.

### Mobile Terminal

Next, the information processing terminal B according to the first embodiment will be described.

FIG. 5 is a block diagram for describing a configuration of the information processing terminal B according to the first embodiment.

The information processing terminal B includes a CPU 201, a storage unit 202, a communication unit 203, a touch panel 204, and a camera 205. The CPU 201 controls various functions of the information processing terminal B by executing programs stored in the storage unit 202. It should be noted that in the first embodiment, a program stored in the storage unit 202 and a program received via the communication unit 203 are executed by the CPU 201. The communication unit 203 includes a communication interface that performs information communication with an external device. In the first embodiment, it is assumed that the communication unit 203 includes a wireless LAN interface as the communication interface. In the first embodiment, the communication unit 203 communicates with the image reading device A and the information processing server C as the external device. Although in the first embodiment, the information processing terminal B is connected to a LAN as illustrated in FIG. 1, it is assumed that the connection is established via a wireless LAN interface.

The touch panel 204 displays a user interface of a program executed by the CPU 201 and receives an input from the user. The camera 205 is an imaging device controlled by the CPU 201. In the first embodiment, the camera 205 is used to read a two-dimensional code.

### Web Browser

In the first embodiment, it is assumed that a web browser is previously installed in the storage unit 202, and the user can operate the web browser using the touch panel 204. The user can also use the web browser to access a web server constructed in the image reading device A and the information processing server C.

### Two-Dimensional Code Reader

In the first embodiment, it is assumed that a two-dimensional code reader is installed in the information processing terminal B. The two-dimensional code reader is an application that analyzes a two-dimensional code contained in an image captured by the camera 205 to extract character string information contained in the two-dimensional code. The user can activate the two-dimensional code reader using the touch panel 204, and capture an image of a two-dimensional code using the touch panel 204. If a character string extracted by the two-dimensional code reader is URL information, the web browser is activated to access the URL. The two-dimensional code reader can also be activated from the web browser. In this case, an extracted character string can be transferred to the web browser. It should be noted that a two-dimensional code reader that performs such an operation is widely available on the market.

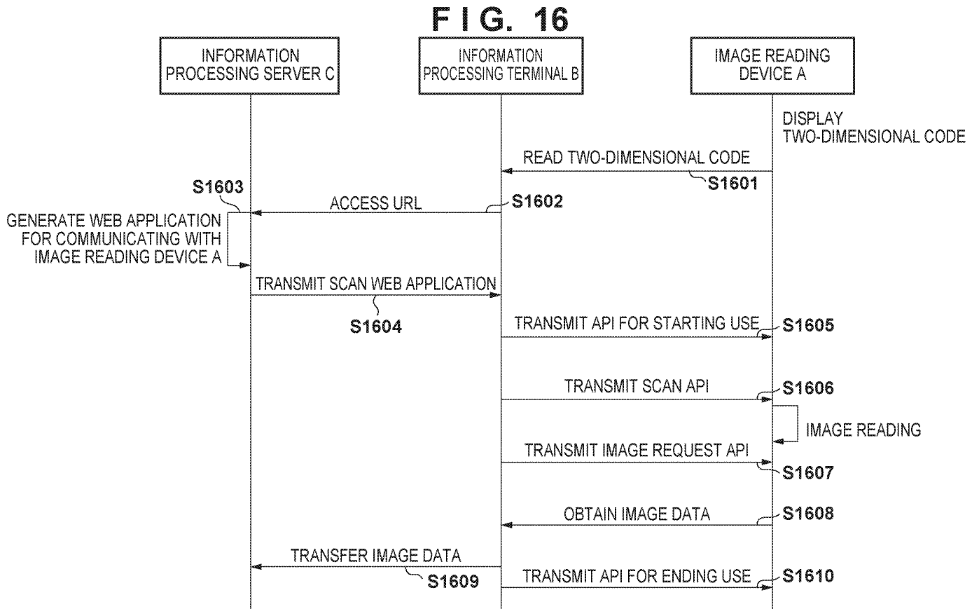

The procedure of processing executed by the image reading device A, the information processing terminal B, and the information processing server C according to the first embodiment will be described below with reference to a sequence diagram illustrated in FIG. 16.

FIG. 16 is a sequence diagram for describing an example procedure of processing in the image reading system according to the first embodiment.

Initially, the image reading device A displays a two-dimensional code on the display unit 94. For example, when a previously stored job for transmitting an image to the information processing server C is selected, a corresponding two-dimensional code is displayed. Furthermore, at this time, an image reading condition (scan setting) may be set before a two-dimensional code is displayed. A two-dimensional code may be displayed if a particular condition is satisfied, or may be invariably displayed. The two-dimensional code contains the URL (http://sample.com/imageservice/) (first connection information) of the information processing server C and the IP address (192.168.0.2) (second connection information) of the image reading device A. Specifically, the image reading device A displays a URL (http://sample.com/imageservice/? scanner_ip=192.168.0.2) obtained by adding the IP address of the image reading device A as an argument to the URL of the information processing server C. In step S1601, the user reads the displayed two-dimensional code using the information processing terminal B, which then analyzes the contents of the code. Next, in step S1602, the information processing terminal B accesses the URL contained in the two-dimensional code.

It should be noted that contents displayed on the image reading device A are merely illustrative, and are not limited as long as the contents contain both of the URL of the information processing server C and the IP address of the image reading device A. The displayed contents may be any contents that can be analyzed by the information processing server C, including the IP address of the image reading device A as a subdirectory instead of an argument (parameter), for example. In other words, the displayed contents may contain the URL of the information processing server C as a connection destination, and the IP address of the image reading device A as connection information that is additionally used at the time of connection to the URL of the information processing server C (a directory level or URL parameter lower than the URL of the information processing server C). The above method for accessing the URL of the information processing terminal B is merely illustrative. A URL newly generated based on the result of reading and analysis of the two-dimensional code may be accessed. For example, a URL obtained by converting http contained in the two-dimensional code into https may be accessed. Alternatively, the URL of the information processing server C and the IP address of the image reading device A may be extracted from the two-dimensional code, and a new URL containing both of the URL of the information processing server C and the IP address of the image reading device A may be accessed.

As a result, in step S1603, the information processing server C generates a web application for communicating with the image reading device A, which has the above IP address. Thereafter, in step S1604, the information processing server C transmits the web application to the information processing terminal B.

As a result, in step S1605, the information processing terminal B executes the received web application to transmit an application programming interface (API) that starts use of the image reading device A. Next, in step S1606, the information processing terminal B transmits a scan API for instructing the image reading device A to start reading an original document (read request). Thereafter, in step S1607, the information processing terminal B transmits, to the image reading device A, an image request API for requesting image data obtained by reading an original document. As a result, in step S1608, in response to the request, the image reading device A transmits image data obtained by reading an original document to the information processing terminal B, which is a request source that has transmitted the request. Thus, the information processing terminal B can obtain image data obtained by the image reading device A reading an original document. Next, in step S1609, the information processing terminal B transmits the image data received from the image reading device A to the information processing server C. Thereafter, in step S1610, the information processing terminal B transmits, to the image reading device A, an API for ending use of the image reading device A.

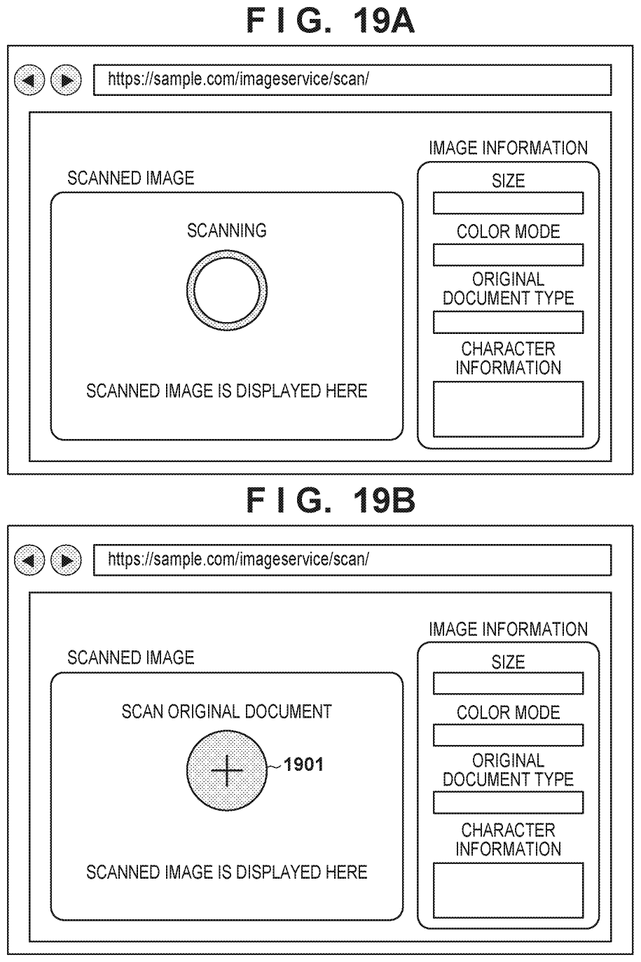

FIG. 19A is a diagram illustrating an example UI screen displayed on the touch panel 204 of the information processing terminal B according to the first embodiment. This screen is displayed during a period of time that the image reading device A is reading an image after being requested to provide image data.

By this process, the user of the information processing terminal B can instruct the image reading device A to read an original document, and cause the information processing terminal B to transmit, to the information processing server C, image data obtained by the image reading device A reading the original document.

A detailed description will be given below.

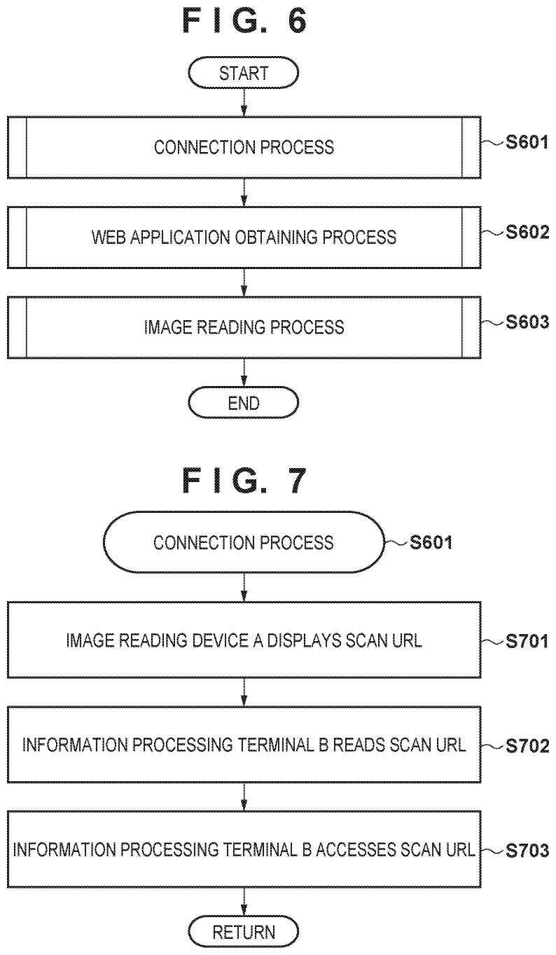

FIG. 6 is a flowchart for describing a reading procedure in the image reading system according to the first embodiment.

Initially, in step S601, connection is established between the image reading device A and the information processing terminal B.

FIG. 7 is a flowchart for describing a connection process of step S601 of FIG. 6.

Initially, in step S701, when the user performs a predetermined operation using the switch 83b of the image reading device A, the image reading device A displays, on the display unit 94, a two-dimensional code obtained by encoding two pieces of information that are information for accessing the information processing server C and information for accessing a web server running in the image reading device A. In the first embodiment, specifically, displayed is a two-dimensional code obtained by encoding the character string “http://sample.com/imageservice/? scanner_ip=192.168.0.2”, which is a concatenation of the URL of the information processing server C and the IP address of the image reading device A as a URL argument.

Next, in step S702, the user activates the two-dimensional code reader of the information processing terminal B, which then reads the two-dimensional code displayed on the display unit 94 of the image reading device A. This corresponds to step S1601 of FIG. 16. Next, the processing proceeds to step S703, in which the two-dimensional code reader extracts, from the two-dimensional code, the argument-added URL encoded in step S701, and activates a web browser, which then accesses the argument-added URL. As a result, connection is established between the information processing terminal B and the information processing server C. After connection is thus established between the information processing terminal B and the information processing server C, the processing proceeds to step S602 of FIG. 6.

Next, in step S602, the information processing terminal B obtains a web application from the information processing server C.

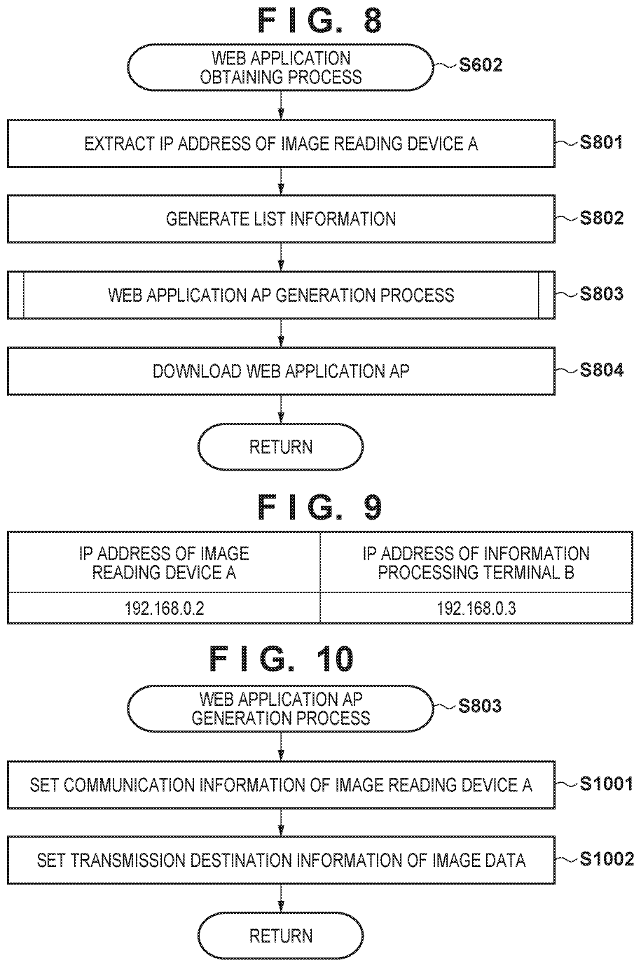

FIG. 8 is a flowchart for describing the flow of a process of causing the information processing terminal B to obtain a web application from the information processing server C in step S602 of FIG. 6.

Initially, in step S801, the information processing server C extracts the IP address “192.168.0.2” of the image reading device A from the URL argument “?scanner_ip=192.168.0.2” that is added to the accessed URL. Next, in step S802, the information processing server C associates the extracted IP address with the IP address of the information processing terminal B, which is an access source that has accessed the information processing server C, to generate list information illustrated in FIG. 9, and stores the list information into a storage unit (not illustrated).

FIG. 9 is a diagram illustrating an example of the list information in which the IP address of the image reading device A according to the first embodiment is associated with the IP address of the information processing terminal B according to the first embodiment. Although the list information of FIG. 9 only indicates a private IP address for the sake of simplicity, a global IP and other information contained in a HTTP request may be stored in the list information as appropriate.

Next, the processing proceeds to step S803, in which the information processing server C generates a web application (JavaScript) AP. It should be noted that the web application AP is executed in the information processing terminal B to provide the function of causing the information processing terminal B to communicate with and control the image reading device A so that the image reading device A reads an image, and to transmit image data of the read image to the information processing server C.

FIG. 10 is a flowchart for describing the flow of a process of causing the information processing server C to generate the web application AP in step S803 of FIG. 8. This process corresponds to step S1603 of FIG. 16. It should be noted that in the first embodiment, it is assumed that a web application AP including the function of controlling an image reading device to transmit image data is previously stored in a storage unit (not illustrated) of the information processing server C. In the following description, it is assumed that, for example, by rewriting a set value of the web application AP, a web application AP is generated.

In step S1001, the information processing server C sets communication information of the image reading device A into the web application AP. Specifically, the IP address information of an image reading device contained in a web application AP previously stored in a storage unit (not illustrated) is rewritten to the IP address of the image reading device A extracted in step S801.

Next, the processing proceeds to step S1002, in which the information processing server C sets transmission destination information of image data into the web application AP. Specifically, the information processing server C rewrites the transmission destination of image data contained in a web application previously stored in a storage unit (not illustrated) to the URL of the information processing server C itself. It should be noted that in the case in which a transmission destination folder or the like corresponding to the IP address of the information processing terminal B previously exists, the information processing server C may rewrite the transmission destination to a URL corresponding to the transmission destination folder or the like. If no transmission destination folder or the like corresponding to the IP address of the information processing terminal B exists at the time of step S1002, the folder may be generated, and the transmission destination may be rewritten to a URL corresponding to the folder. Alternatively, in the web application AP, the URL of the information processing server C may only be previously set as the transmission destination of image data. In that case, when image data is received from the image reading device A as described below (step S1308), the image data may be transmitted in such a manner that the transmission source can be identified.

According to the above procedure, the IP address of the image reading device A is embedded in the generated web application AP, and therefore, the information processing terminal B can communicate with the image reading device A via a network. In addition, because the URL of the information processing server C is also embedded, the image reading device A and the information processing terminal B can also communicate with the information processing server C via a network.

Although in the first embodiment, an application generated by the information processing server C is a web application AP, the information processing server C may generate any application that can be executed by the information processing terminal B. It should be noted that if the application does not need to be installed in the information processing terminal B, the user's convenience is preferably improved.

In addition, in the case of an application that can be executed on the web browser of the information processing terminal B, the user can continue to perform operations on the web browser after the information processing terminal B accesses the information processing server C using the web browser in step S601. Therefore, the user's convenience is preferably improved.

If the information processing server C thus generates the web application AP, the processing proceeds to step S804, in which the information processing terminal B downloads the web application AP generated in step S803 from the information processing server C (corresponding to step S1604 of FIG. 16). If the web application AP is executable on the web browser, the web application AP is displayed as a web page on the web browser of the information processing terminal B. After the information processing terminal B thus obtains the web application AP (accesses the web application AP), the processing automatically proceeds to step S603 of FIG. 6, in which an image reading process is executed. In this reading process, the information processing terminal B causes the image reading device A to read an original document, and obtains and transmits the image data obtained by the image reading device A to the information processing server C. It should be noted that image reading conditions at this time may be conditions set for a job or the like selected for displaying a two-dimensional code. In addition, in the case in which such image reading conditions can be set when a job or the like is selected, the setting is applied.

FIG. 19B is a diagram illustrating an example UI screen displayed on the touch panel 204 of the information processing terminal B according to the first embodiment.

In the foregoing description, when the information processing terminal B accesses the URL of the information processing server C, the information processing terminal B automatically downloads the web application AP and starts scanning. However, the screen of FIG. 19B may be displayed on the touch panel 204 of the information processing terminal B, and when the user presses a button 1901, the image reading device A may be caused to execute an image reading process. In that case, at this time, image reading conditions may be able to be set as illustrated on the right side of the screen of FIG. 19B.

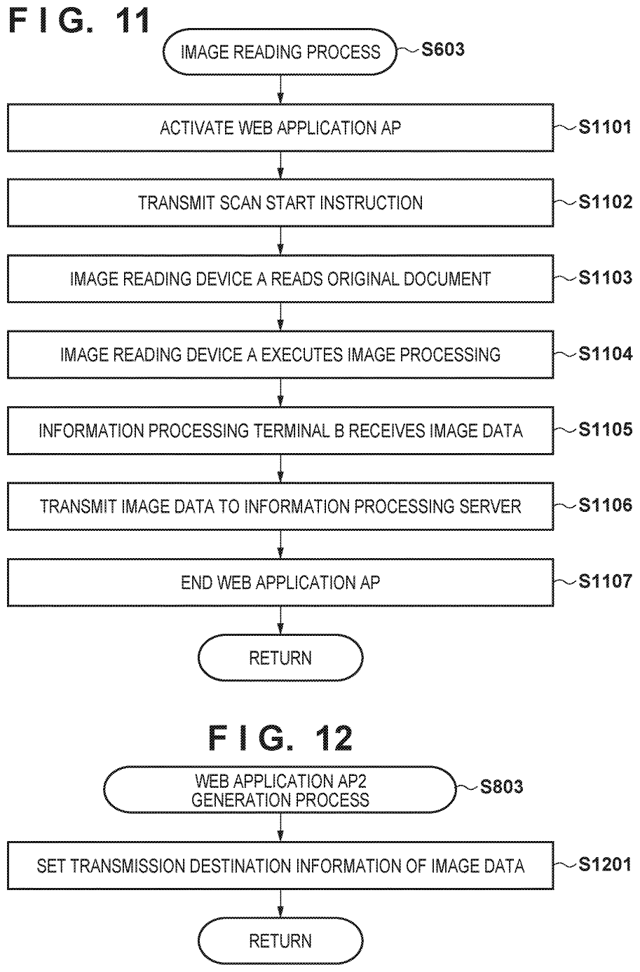

FIG. 11 is a flowchart for describing a process of reading an original document using the information processing terminal B and the image reading device A and transmitting data of the read image to the information processing server C in step S603 of FIG. 6 according to the first embodiment. It should be noted that this process corresponds to steps S1605 to S1610 of FIG. 16.

In step S1101, the information processing terminal B activates the web application AP obtained from the information processing server C in step S602, and then transmits, to the image reading device A, an API for starting use of the image reading device A. Next, the processing proceeds to step S1102, in which the information processing terminal B, which is executing the web application AP, transmits an instruction to start scanning to the image reading device A (corresponding to step S1606).

As a result, in step S1103, the image reading device A transports original documents stacked on the feed tray 1 and reads images of the original documents. That is, the CPU 81 of the image reading device A starts controlling the actuator 86, transports the lowest one of transport media S stacked on the feed tray 1, reads an image using the image reading unit 70, stores the obtained image data into the storage unit 82, and ejects the original document. This process is repeatedly executed until none of the original documents stacked on the feed tray 1 is left.

Although in the first embodiment, image reading is performed until none of the original documents stacked on the feed tray 1 is left, the present invention is not limited to this. Only a predetermined number of original documents may be read. In that case, an item for setting the number of original documents to be read may be added to a reading setting screen for setting image reading conditions displayed at one of the above timings.

Next, the processing proceeds to step S1104, in which the image reading device A executes image processing on the obtained image data and stores the resultant data into the storage unit 82. The type of the image processing is not particularly limited. Examples of the image processing include correction of the brightness and color of an image, removal of an unnecessary marginal region, and removal of a blank image.

Next, the processing proceeds to step S1105, in which the information processing terminal B, which is executing the web application AP, instructs the image reading device A to transmit data of the read image (corresponding to step S1607). As a result, in step S1105, the image reading device A transmits the image data stored in the storage unit 82 to the information processing terminal B via a network. Thus, the information processing terminal B obtains the image data obtained by scanning (corresponding to step S1608). Next, the processing proceeds to step S1106, in which the information processing terminal B, which is executing the web application AP, transmits the image data received from the image reading device A to the information processing server C (corresponding to step S1609).

The information processing server C, which has thus received the image data, searches the list information illustrated in FIG. 9 that is stored in a storage unit (not illustrated), and deletes information containing the IP address of the transmission source of the image data. Thereafter, the processing proceeds to step S1107, in which the information processing terminal B ends the web application AP (corresponding to step S1610). It should be noted that this ending process may be executed by the web application AP instructing the information processing terminal B to execute a process of ending the web application AP itself. Alternatively, as the ending process, a continuation scan setting screen on which it can be determined whether to continue to similarly read image data may be displayed, and if it is determined to continue to read image data, reading may be executed or transition may be performed to a screen for setting image reading conditions, and an instruction transmitted such that the IP addresses of the image reading device A and the information processing terminal B are set into the list information again in the information processing server C. It should be noted that the IP addresses or the like of the image reading device A and the information processing terminal B are contained as information in the web application AP, and therefore, may be extracted from the web application AP and transmitted to the information processing server C.

As described above, according to the first embodiment, the display unit included in the image reading device only needs to display a two-dimensional code (code image), and does not need to display complicated information and does not require complicated operations. Therefore, an increase in the size and cost of the image reading device can be avoided. It should be noted that the two-dimensional code is merely illustrative, and other code images may be used.

Furthermore, according to the first embodiment, the user of the information processing terminal B does not need to input information such as an IP address needed to communicate with an image reading device into the information processing terminal B, or previously store such information into the information processing server C. Therefore, the user's convenience can be improved.

It should be noted that in the first embodiment, as illustrated in FIG. 9, the information processing server C associates the IP address of the image reading device A with the IP address of the information processing terminal B to manage these IP addresses. As a result, the information processing server C can determine what image reading device has obtained image data transmitted from the web application AP. It should be noted that this management method is merely illustrative. For example, the IP address of the image reading device A may be managed in association with a non-redundant, unique number or the like. In that case, a unique number or the like may be embedded in the web application AP when the web application AP is generated. If the web application AP adds the unique number or the like to information when the web application AP transmits the information to the information processing server C, the information processing server C can identify an image reading device.

Although in the first embodiment, the web application AP only communicates with the image reading device A, the present invention is not limited to this. Alternatively, the web application AP may simultaneously display the progress of processing on the display unit of the information processing terminal B or regularly communicate with the information processing server C.

Although in the first embodiment, the web application AP is ended after the web application AP transmits image data to the information processing server C, the present invention is not limited. Alternatively, for example, the web application AP may display the result of processing of image data by the information processing server C.

Although in the first embodiment, the image reading device A displays a two-dimensional code on the display unit 94, the image reading device A may print out a two-dimensional code, which is then read by the information processing terminal B, in the case in which the image reading device A is a multifunctional printer, for example.

Although in the first embodiment, an example has been described in which the URL of the information processing server C is previously stored in the image reading device A, the present invention is not limited to this. Alternatively, for example, the image reading device A may display a code image that can display an input screen (web application) which allows input of the URL of the information processing server C. In that case, if as a result of reading with a camera, access through a web browser is allowed, the IP address of the image reading device A may be displayed instead of the code image. By inputting the URL of the information processing server C to the input screen thus displayed, the process of obtaining a web application described in step S602 and the following processes may be executed.

### Second Embodiment

Next, a second embodiment of the present invention will be described. It should be noted that the configuration of an image reading system according to the second embodiment and the hardware configurations and the like of an image reading device A and an information processing terminal B according to the second embodiment are similar to those of the first embodiment described above, and therefore, will not be described. The second embodiment is a variation of the first embodiment. The second embodiment is different from the first embodiment in a method with which a web application running in the information processing terminal B acquires the IP address of the image reading device A. This difference will be described below in detail.

In the second embodiment, it is assumed that the URL of the information processing server C is embedded in a web application AP2 that is generated by the information processing server C in step S1703, and the IP address of the image reading device A is not embedded in the web application AP2.

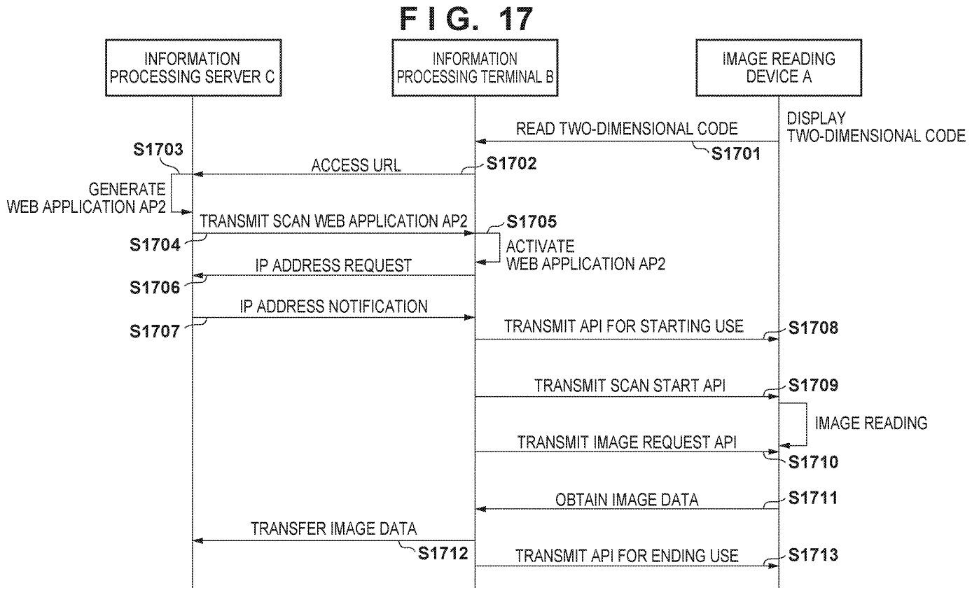

FIG. 17 is a sequence diagram for describing an example procedure of processing in the image reading system according to the second embodiment.

Initially, the image reading device A displays a two-dimensional code on the display unit 94. The two-dimensional code contains the URL (http://sample.com/imageservice/) of the information processing server C and the IP address (192.168.0.2) of the image reading device A. Specifically, the image reading device A displays a URL (http://sample.com/imageservice/? scanner_ip=192.168.0.2) obtained by adding the IP address of the image reading device A as an argument to the URL of the information processing server C. In step S1701, the user reads the displayed two-dimensional code using the information processing terminal B, which then analyzes the contents of the code. Next, in step S1702, the information processing terminal B accesses the URL contained in the two-dimensional code.

It should be noted that the displayed contents of the image reading device A are merely illustrative, and are not limited as long as the URL of the information processing server C and the IP address of the image reading device A are both contained. The above method for accessing the URL of the information processing terminal B is merely illustrative. A URL that is newly generated based on the result of reading and analysis of the two-dimensional code may be accessed. For example, a URL that is obtained by converting http contained in the two-dimensional code into https may be accessed. Alternatively, the URL of the information processing server C and the IP address of the image reading device A may be extracted from the two-dimensional code, and a new URL containing both of the URL of the information processing server C and the IP address of the image reading device A may be accessed.

As a result, in step S1703, the information processing server C generates a web application AP2 for transmitting image data to the information processing server C itself. Thereafter, in step S1704, the information processing server C transmits the web application AP2 to the information processing terminal B. It should be noted that at this time, the information processing server C may previously create a web application for transmitting image data to the information processing server C itself, and add communication information of the image reading device A to the web application, to generate the web application AP2.

Thereafter, in step S1705, the information processing terminal B activates the received web application AP2. At this time, the web application AP2 does not contain the IP address of the image reading device A. Therefore, in step S1706, the information processing terminal B requests the IP address of the image reading device A, which is to perform scanning, from the information processing server C. In step S1707, in response to this, the information processing server C transmits the IP address of the image reading device A to the information processing terminal B. The following steps S1708 to S1713 are similar to steps S1605 to S1610 of FIG. 16 and therefore will not be described.

By this process, as in the first embodiment, the user of the information processing terminal B can instruct the image reading device A to read an original document, and cause the information processing terminal B to transmit, to the information processing server C, image data obtained by the image reading device A reading the original document.

A detailed description will be given below.

FIG. 12 is a flowchart for describing a process of generating the web application AP2 that is executed by the information processing server C according to the second embodiment of the present invention (step S1703).

In step S1201, the information processing server C sets transmission destination information of image data into the web application AP2. Specifically, the information processing server C rewrites the transmission destination of image data contained in a web application previously stored in a storage unit (not illustrated) to the URL of the information processing server C itself. According to this procedure, the URL of the information processing server C is embedded in the generated web application AP2, and therefore, the information processing terminal B, which executes the web application AP2, can communicate with the information processing server C via a network.

However, here, the IP address of the image reading device A is not embedded in the web application AP2. Therefore, as indicated in steps S1705 to S1707, the information processing terminal B, when executing the web application AP2, obtains the IP address of the image reading device A from the information processing server C.

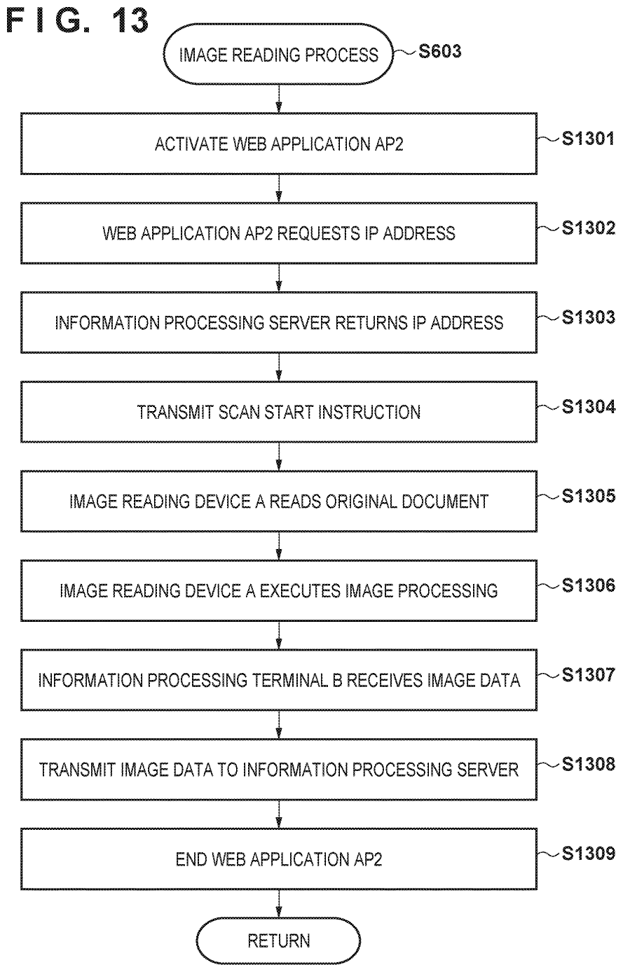

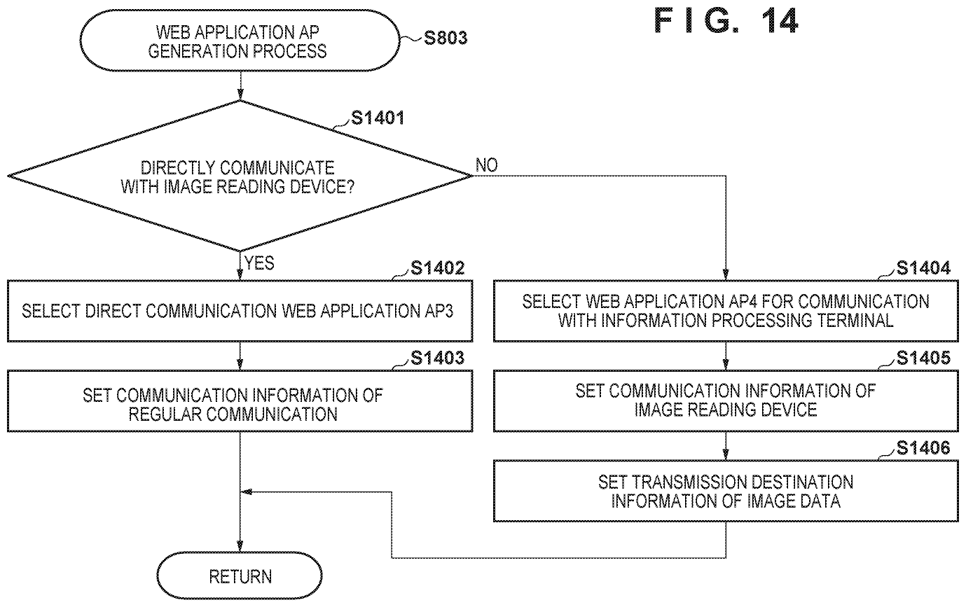

FIG. 13 is a flowchart for describing a process of reading an original document using the image reading device A and the information processing terminal B according to the second embodiment and transmitting data of the read image to the information processing server C according to the second embodiment. As described below, in this process, the IP address of the image reading device A is received from the information processing server C.

In step S1301, as in step S1101, the information processing terminal B activates the web application AP2 (corresponding to step S1705). Next, the processing proceeds to step S1302, in which the information processing terminal B, which is executing the web application AP2, transmits, to the information processing server C, a request for obtaining the IP address of the image reading device A (corresponding to step S1706). As a result, in step S1303, after receiving the request for obtaining the IP address, the information processing server C searches list information (see, for example, FIG. 9) stored in a storage unit (not illustrated), refers to information containing the IP address of the transmission source of image data, and returns the IP address of the image reading device A (corresponding to step S1707). The following steps S1304 to S1309 are similar to those of steps S1102 to S1107 of FIG. 11 and therefore will not be described.

As described above, according to the second embodiment, even in the case in which the IP address of the image reading device A is not embedded in the web application AP2 obtained from the information processing server C, the information processing terminal B, which executes the web application AP2, can communicate with the image reading device A.

In the first and second embodiments, the information processing server C only communicates with the information processing terminal B, and the image reading device A only communicates with the information processing terminal B. Therefore, the first and second embodiments are applicable to even the case in which the information processing server C and the image reading device A cannot directly communicate with each other. Specifically, the first and second embodiments are also applicable to the case in which communication with the information processing server C is performed via the Internet, and communication with an IP address assigned to the image reading device A cannot be performed via the Internet.

Although in the second embodiment, the information processing terminal B inquires, of the information processing server C, the IP address of the image reading device A, the present invention is not limited to this. For example, the IP address of the image reading device A is contained in the two-dimensional code read in step S1701, and therefore, the information processing terminal B may obtain the IP address of the image reading device A from the two-dimensional code.

In the case in which there are a plurality of users (information processing terminals B) of the image reading device A, then if the information processing server C may limit the number of information processing terminals B to which the information processing server C returns the IP address of the image reading device A to one in step S1707 of FIG. 17, multiple users may be forbidden to simultaneously use the image reading device A.

### Third Embodiment

Next, a third embodiment of the present invention will be described. It should be noted that the configuration of an image reading system according to the third embodiment and the hardware configurations of an image reading device A and an information processing terminal B according to the third embodiment are similar to those of the first embodiment described above, and therefore, will not be described. The third embodiment is a variation of the first embodiment. The third embodiment is different from the first embodiment in that a web application running in the information processing terminal B does not communicate with the image reading device A, and the information processing server C communicates with the image reading device A. This difference will be described below in detail.

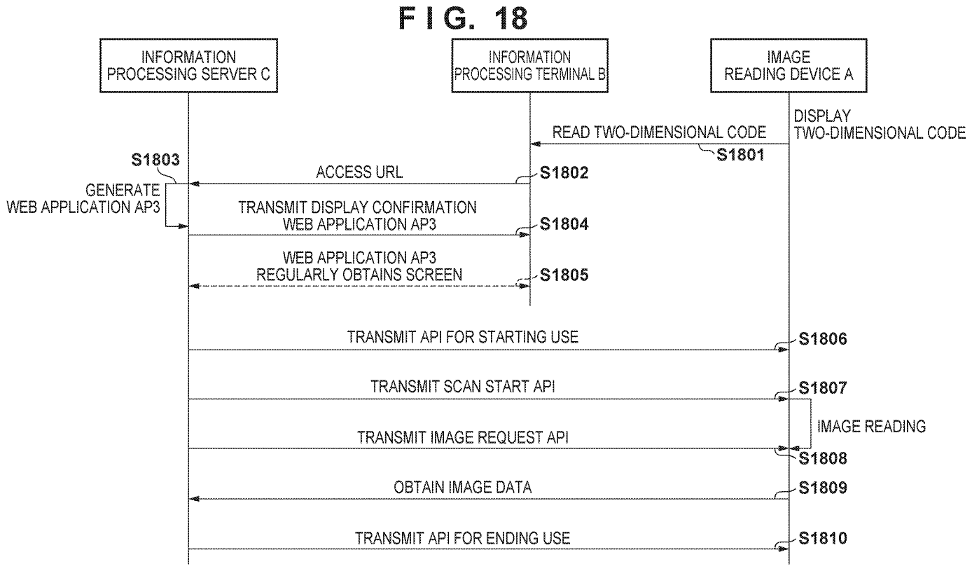

FIG. 18 is a sequence diagram for describing an example procedure of processing in the image reading system according to the third embodiment.

Initially, the image reading device A displays a two-dimensional code on the display unit 94. The two-dimensional code contains the URL (http://sample.com/imageservice/) of the information processing server C and the IP address (192.168.0.2) of the image reading device A. Specifically, the image reading device A displays a URL (http://sample.com/imageservice/? scanner_ip=192.168.0.2) obtained by adding the IP address of the image reading device A as an argument to the URL of the information processing server C. In step S1801, the user reads the displayed two-dimensional code using the information processing terminal B, which then analyzes the contents of the code. Next, in step S1802, the information processing terminal B accesses the URL contained in the two-dimensional code.

It should be noted that the displayed contents of the image reading device A are merely illustrative, and are not limited as long as the URL of the information processing server C and the IP address of the image reading device A are both contained. The above method for accessing the URL of the information processing terminal B is merely illustrative. A URL that is newly generated based on the result of reading and analysis of the two-dimensional code may be accessed. For example, a URL that is obtained by converting http contained in the two-dimensional code into https may be accessed. Alternatively, the URL of the information processing server C and the IP address of the image reading device A may be extracted from the two-dimensional code, and a new URL containing both of the URL of the information processing server C and the IP address of the image reading device A may be accessed.

As a result, in step S1803, the information processing server C generates a display confirmation web application AP3. Thereafter, in step S1804, the information processing server C transmits the display confirmation web application AP3 to the information processing terminal B. Because the display confirmation web application AP3 does not communicate with the image reading device A, the display confirmation web application AP3 does not contain the IP address of the image reading device A. Therefore, unlike the first embodiment, it is not necessary to create the web application AP3 for each image reading device. Thereafter, in step S1805, the information processing terminal B, which executes the display confirmation web application AP3, regularly accesses the information processing server C and displays the progress (scan is being performed, the process has been ended, etc.).

Next, in step S1806, the information processing server C transmits an application programming interface (API) for starting use of the image reading device A. Next, in step S1807, the information processing server C transmits a scan API for instructing the image reading device A to start reading an original document. Thereafter, in step S1808, the information processing server C transmits, to the image reading device A, an image request API for requesting image data obtained by reading the original document. As a result, in step S1809, in response to the request, the image reading device A transmits the image data obtained by reading the original document to the information processing server C. Thus, the information processing server C obtains the image data from the image reading device A. Thereafter, in step S1810, the information processing server C transmits, to the image reading device A, an API for ending use of the image reading device A.

By this process, as in the above embodiments, the user of the information processing terminal B can instruct the image reading device A to read an original document, and the information processing server C can acquire image data obtained by reading the original document using the image reading device A.

A detailed description will be given below.

FIG. 14 is a flowchart for describing a process of generating a web application AP3 using the information processing server C according to the third embodiment. In the third embodiment, the information processing server C determines whether to directly communicate with the image reading device A. When determining to directly communicate with the image reading device A, the information processing server C generates a web application AP3 that is used for the direct communication. Meanwhile, when determining not to directly communicate with the image reading device A, the information processing terminal C generates a web application AP3 that allows the information processing terminal B to communicate with the image reading device A as in the first embodiment.

In the third embodiment, it is assumed that two web applications are previously stored in a storage unit (not illustrated) of the information processing server C. One (web application AP3) of the stored web applications regularly communicates with the information processing server C, and displays the progress of processing on a display unit of the information processing terminal B, and is used in the case in which the information processing server C directly communicates with the image reading device A. The other (web application AP4) stored web application controls the image reading device A to transmit image data as in the first embodiment, and is used in the case in which the information processing server C does not directly communicate with the image reading device A.

In step S1401, the information processing server C determines whether to directly communicate with the image reading device A. In the third embodiment, it is assumed that the determination is made based on whether the information processing server C can communicate with the IP address extracted by the information processing server C in step S801. Specifically, the information processing server C sends a ping request to the extracted IP address, and determines whether a response is received within a predetermined period of time. In the third embodiment, it is assumed that a response is received within a predetermined period of time with respect to a ping request sent to the extracted IP address by the information processing server C, and the information processing server C determines to directly communicate with the image reading device A. In this case, the processing proceeds to step S1402.

It should be noted that an information processing server may use other methods to determine whether to directly communicate with an image reading device. For example, the IP address extracted in step S801 may be analyzed, and the determination may be made based on whether the information processing server C can communicate with the IP address. Alternatively, the determination may be made based on whether the information processing terminal B, which is an access source, and a web browser used in access, can execute a web application having the function of controlling the image reading device A to transmit image data. Alternatively, the determination may be made when a two-dimensional code is displayed on the image reading device A. In that case, the result of the determination may be transferred using an argument when access is performed in step S1802.

If the information processing server C determines to directly communicate with the image reading device A, the processing proceeds to step S1402, in which the information processing server C selects one of the two web applications stored in a storage unit (not illustrated), that is to be used in the following process. Specifically, a web application AP3 for regularly communicating with the information processing server C and displaying the progress of processing on a display unit of the information processing terminal B is selected. Thereafter, the processing proceeds to step S1403, in which the information processing server C sets information about a communication destination with which communication is regularly performed into the web application AP3 selected in step S1402. Specifically, the information processing server C rewrites a communication destination contained in the web application AP3 previously stored in a storage unit (not illustrated) to the URL thereof.

Meanwhile, if in step S1401, the information processing server C does not determine to directly communicate with the image reading device A, the processing proceeds to step S1404. In step S1404, the information processing server C selects, from the two web applications stored in a storage unit (not illustrated), a web application AP4 for controlling an image reading device to transmit image data. It should be noted that this web application is similar to the web application AP used in the first embodiment. Next, the processing proceeds to step S1405, in which the information processing server C sets communication information of the image reading device A into the web application AP4 selected in step S1404. This process is similar to step S1001 of FIG. 10. Thereafter, the processing proceeds to step S1406, in which the information processing server C sets transmission destination information of image data into the web application AP4 selected in step S1404. This process is similar to step S1002 of FIG. 10.

According to the process described above, an appropriate web application can be generated based on whether the information processing server C directly communicates with the image reading device A.

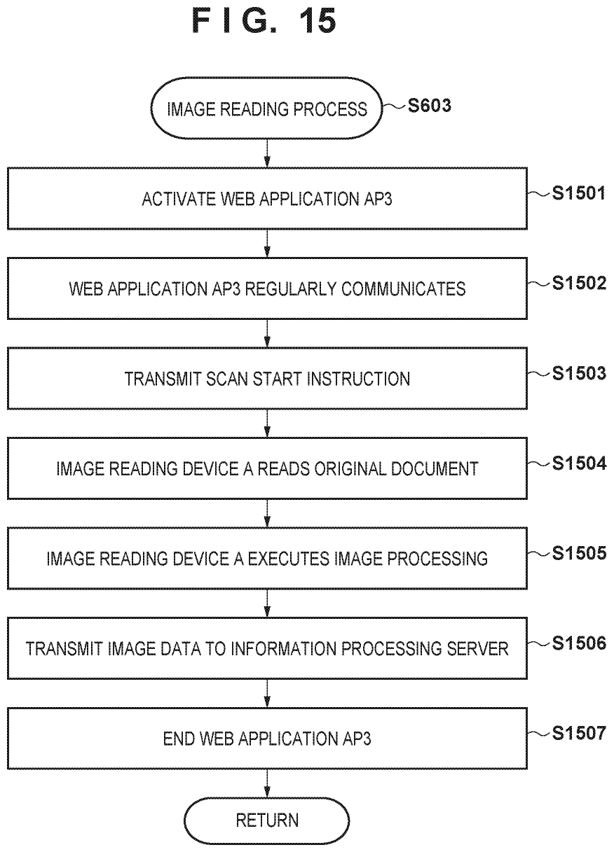

FIG. 15 is a flowchart for describing a process of reading an original document using the image reading device A and the information processing terminal B according to the third embodiment and transmitting data of the read image to the information processing server C according to the third embodiment. It should be noted that in the third embodiment, in step S1401 the information processing server C determines to directly communicate with the image reading device A, and therefore, here, only a method for causing the information processing server C to directly communicate with the image reading device A will be described. In the case in which in step S1401 the information processing server C does not determine to directly communicate with the image reading device A, a process similar to that of the first embodiment may be executed.

In step S1501, the information processing terminal B executes the web application AP3 obtained from the information processing server C in step S602 of FIG. 6. Next, the processing proceeds to step S1502, in which the information processing terminal B, which is executing the web application AP3, starts regularly communicating with the information processing server C. The information processing terminal B, which is executing the web application AP3, obtains the progress of processing from the information processing server C through the regular communication, and displays the progress of processing on a display unit of the information processing terminal B (corresponding to step S1805). As described below, a process of ending the web application AP3 is also executed based on the regular communication.

Next, the processing proceeds to step S1503, in which the information processing server C transmits an instruction to start scanning to the image reading device A (corresponding to steps S1806 and S1807). As a result, in step S1504, the image reading device A transports an original document placed on the feed tray 1 and reads an image of the original document as in step S1103 of FIG. 11. Thereafter, the processing proceeds to step S1505, in which the image reading device A executes image processing on the read image as in step S1104 of FIG. 11. Thereafter, the processing proceeds to S1506, in which the information processing server C instructs the image reading device A to transmit data of the read image (corresponding to step S1808). As a result, the image reading device A transmits the image data obtained and processed to the information processing server C via a network. As a result, the information processing server C obtains image data obtained by scanning performed by the image reading device A (corresponding to step S1809). Next, the processing proceeds to step S1507, in which the information processing server C ends the web application AP3, which is being executed in the information processing terminal B (corresponding to step S1810). Specifically, when receiving the regular communication from the web application AP3 after receiving the image data in step S1506, the information processing server C returns, to the web application AP3, information indicating the end of the web application AP3. When receiving this information, the web application AP3 instructs the information processing terminal B to execute a process of ending the web application AP3 itself.

In the third embodiment, the information processing server C directly communicates with the image reading device A, and image data is directly transmitted to the information processing server C not via the information processing terminal B. Therefore, there is substantially no possibility that information leaks from the information processing terminal B, resulting in an improvement in security.

### Fourth Embodiment

Next, a fourth embodiment of the present invention will be described. It should be noted that the configuration of an image reading system according to the fourth embodiment and the hardware configurations and the like of an image reading device A and an information processing terminal B according to the fourth embodiment are similar to those of the first embodiment described above, and therefore, will not be described. The fourth embodiment is a variation of the first embodiment. The fourth embodiment is different from the first embodiment in the destination of image data transmitted by the image reading device A. Although in the first embodiment, the image data is transmitted to the information processing server C via the information processing terminal B, the image data is transmitted to an information processing server D that is a second information processing server in the fourth embodiment. This difference will be described below in detail.

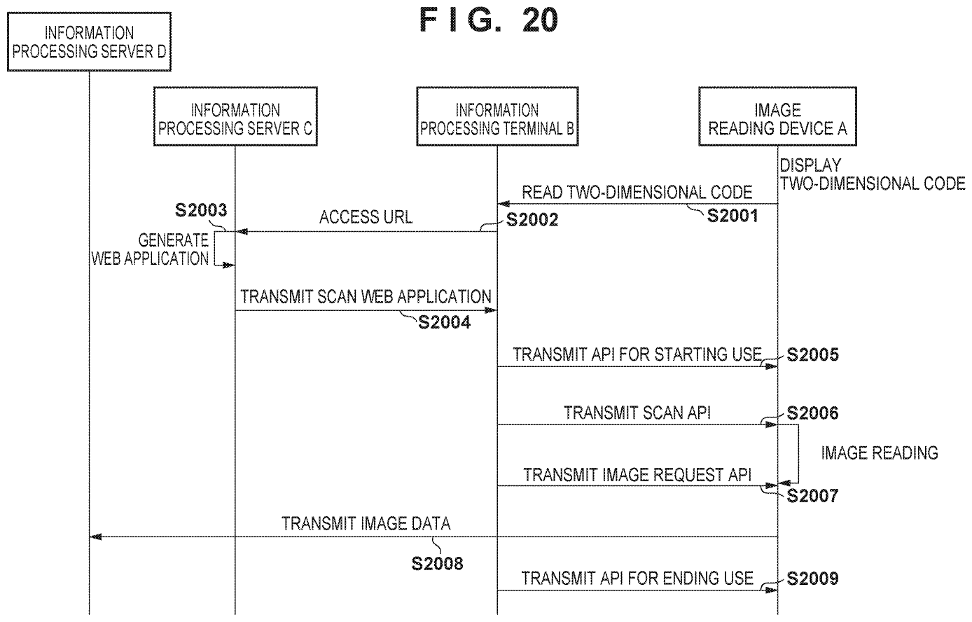

FIG. 20 is a sequence diagram for describing an example procedure of processing in the image reading system according to the fourth embodiment.

Steps S2001 to S2006 are similar to steps S1601 to S1606 of FIG. 16 and therefore will not be described.

In S2007, the information processing terminal B transmits, to the image reading device A, an image request API for requesting image data obtained by reading an original document. It should be noted that in the fourth embodiment, it is assumed that the image request API contains information indicating the transmission destination of image data. Specifically, it is also assumed that as the information indicating the transmission destination of image data, destination information of the information processing server D that is a second information processing server is contained.

In S2008, the image reading device A transmits image data obtained by reading an original document in accordance with the destination information contained in the image request API received in S2007. In the fourth embodiment, the image data is transmitted to the information processing server D.

In S2009, the information processing terminal B transmits, to the image reading device A, an API for ending use of the image reading device A.

As described above, according to the fourth embodiment, image data obtained by the image reading device A can be transmitted to another transmission destination that is different from the information processing terminal B and the information processing server C. As a result, generation of a web application, and reception and accumulation of image data, can be executed in different information processing servers, and therefore, the load of an information processing server can be distributed.

Although in the fourth embodiment, the image request API contains information indicating the transmission destination of image data, the image request API may further contain authentication information for transmitting image data to a transmission destination. Furthermore, the image reading device A may execute an authentication process based on the authentication information. For example, if the information processing server D is configured to require log-in information when receiving image data, the image request API may contain the log-in information, and the image reading device A may log in to the information processing server D using the log-in information before transmitting image data.

Although in the first to third embodiments, the information processing server C performs both generation of a web application and reception of image data, the present invention is not limited. As illustrated in the fourth embodiment, these processes may be executed in different information processing servers. For example, when a web application is generated, the URL of a second information processing server may be previously embedded as the transmission destination of image data in the web application, and the web application may transmit the image data to the URL of the second information processing server.

In addition, for example, in order to identify a scan instruction to scan an image from which image data to be transmitted to the information processing server C has been obtained, an identification number may be added to the image data. For example, the information processing server C may create and incorporate an identification number into a web application. The identification number may be added to image data received from the image reading device A by the information processing terminal B executing the web application before the image data is transmitted to the information processing server C.

It may also be assumed that before a web application transmits image data, the web application may transmit a request for obtaining the transmission destination of the image data to the information processing server C, the information processing server C may return the URL of a second information processing server, and the web application may transmit the image data to the URL of the second information processing server. Alternatively, it may be assumed that a web application displays a screen for inquiring, of a user, the transmission destination of image data on a display unit of the information processing terminal B, causes the user to input the transmission destination, and transmits the image data to the input transmission destination.

Although in each embodiment described above, the information processing terminal B transmits image data received from the image reading device A to the information processing server C or the information processing server D, this may be performed by a web application on the information processing terminal B, or by software such as the operating system (OS) of the information processing terminal B other than a web application.

### Other Embodiments

The present invention can be implemented by a process of supplying a program for implementing one or more functions of the above embodiments to a system or device via a network or storage medium, and causing one or more processors of a computer of the system or device to read and execute the program. The present invention can also be implemented by a circuit implementing one or more functions (e.g., an ASIC).

The present invention is not limited to the above embodiments, and various changes and modifications can be made thereto without departing from the spirit and scope of the present invention. In addition, the embodiments may be carried out in combination as appropriate, and only a portion of configurations, processes, and the like of the plurality of embodiments may be combined.

What is claimed is:

1. An image reading device comprising:
an image reader configured to read an image of a document; and
one or more controllers including one or more processors and one or more memories, wherein the one or more controllers are configured to:
output a code image readable by a terminal device; and
perform control to transmit, in response to an image read request, image data obtained by reading a document using the image reader, to a request source of the read request,
wherein the code image contains first connection information for the terminal device to communicably connect to an information processing device, and second connection information for the information processing device or the terminal device to communicably connect to the image reading device.

2. The image reading device according to claim 1, wherein
the request source is the terminal device, and the terminal device issues the read request by executing a program received from the information processing device.

3. The image reading device according to claim 1, wherein
the request source is the information processing device, and the information processing device issues the read request by executing a program generated by the information processing device.

4. The image reading device according to claim 1, wherein
the first connection information contains a uniform resource locator (URL) of the information processing device.

5. The image reading device according to claim 1, wherein
the second connection information contains an IP address of the image reading device.

6. The image reading device according to claim 2, wherein
the code image contains information obtained by adding an IP address of the image reading device as an argument to a URL of the information processing device, and the program designates the URL of the information processing device as a transmission destination of the image data.

7. An image reading system comprising an information processing device, a terminal device, and an image reading device,
the image reading device comprising:
an image reader configured to read an image of an original document; and
one or more first controllers including one or more first processors and one or more first memories, wherein the one or more first controllers are configured to:
output a code image readable by the terminal device; and
perform control to transmit, in response to an image read request, image data obtained by reading an original document using the image reader to a request source of the read request,
the code image containing first connection information for the terminal device to communicably connect to the information processing device, and second connection information for the information processing device or the terminal device to communicably connect to the image reading device, and
the terminal device comprising:
a first communication unit configured to perform communication;
a camera configured to read the code image output by the image reading device; and
one or more second controllers including one or more second processors and one or more second memories, wherein the one or more second controllers are configured to:
extract the first connection information and the second connection information from the code image obtained by the camera; and
perform control to, using the first communication unit, communicate with the information processing device based on the first connection information and communicate with the image reading device based on the second connection information.

8. The image reading system according to claim 7, wherein
the information processing device comprises:
a second communication unit configured to perform communication; and
one or more third controllers including one or more third processors and one or more third memories, wherein the one or more third controllers are configured to:
generate a program executable by the terminal device; and
transmit the generated program to the terminal device using the second communication unit and cause the terminal device to execute the program.

9. The image reading system according to claim 8, wherein
the one or more third controllers of the information processing device are configured to:
transmit an image read request to the image reading device using the second communication unit, and receive image data obtained by the image reading device in response to the read request.

10. An image reading system having an information processing device, a terminal device, and an image reading device,
the information processing device comprising:
one or more first controllers including one or more first processors and one or more first memories, wherein the one or more first controllers are configured to:
transmit a web application to the terminal device,
wherein the terminal device comprising:
one or more second controllers including one or more second processors and one or more second memories, wherein the one or more second controllers are configured to:
cause the image reading device to read an image of an original document by executing the web application.

11. The image reading system according to claim 10, wherein
the web application contains identification information of the image reading device, and
the one or more second controllers of the terminal device are configured to cause the image reading device to read an image of the original document, based on the identification information, by executing the web application.

12. The image reading system according to claim 10, wherein
in a case where the web application does not contain identification information of the image reading device, the one or more second controllers of the terminal device that execute the web application obtain the identification information from the information processing device to cause the image reading device to read an image of the original document.

13. The image reading system according to claim 10, wherein
the one or more second controllers of the terminal device obtain image data of the original document from the image reading device by executing the web application, and transmit the image data to the information processing device.

14. The image reading system according to claim 10, wherein
the one or more second controllers of the terminal device that execute the web application access the information processing device and cause the image reading device to read an image of the original document via the information processing device, and the information processing device obtains the image data of the original document from the image reading device.

15. A method of controlling an image reading device having an image reader configured to read an image of an original document, comprising:
outputting a code image readable by a terminal device; and
performing control to transmit, in response to an image read request, image data obtained by reading an original document using the image reader to a request source of the read request,
wherein the code image contains first connection information for the terminal device to communicably connect to an information processing device, and second connection information for the information processing device or the terminal device to communicably connect to the image reading device.

16. A method of controlling an image reading device having an image reader configured to read an image of an original document, comprising:
outputting a code image readable by a terminal device and containing first connection information for communicably connecting to an information processing device as a connection destination and second connection information additionally used upon connection using the first connection information and for communicably connecting to the image reading device;
reading an original document using the image reader based on a read request issued based on access to the information processing device from the terminal device that read the code image; and
transmitting a web application for performing display related to the read request, from the information processing device to the terminal device.

17. A non-transitory computer-readable storage medium storing a program for causing a processor to execute a method of controlling an image reading device having an image reader configured to read an image of an original document, the method comprising:
outputting a code image readable by a terminal device; and
performing control to transmit, in response to an image read request, image data obtained by reading an original document using the image reader to a request source of the read request,
wherein the code image contains first connection information for the terminal device to communicably connect to an information processing device, and second connection information for the information processing device or the terminal device to communicably connect to the image reading device.

18. A non-transitory computer-readable storage medium storing a program for causing a processor to execute a method of controlling an image reading device having an image reader configured to read an image of an original document, comprising:
outputting a code image readable by a terminal device and containing first connection information for communicably connecting to an information processing device as a connection destination and second connection information additionally used upon connection using the first connection information and for communicably connecting to the image reading device;
reading an original document using the image reader based on a read request issued based on access to the information processing device from the terminal device that read the code image; and
transmitting a web application for performing display related to the read request, from the information processing device to the terminal device.
